(19) United States
(12) Patent Application Publication
(10) Pub. No.: US 2022/0082164 A1
(43) Pub. Date: Mar. 17, 2022

(54) INTEGRATED SLEW DRIVES FOR ACTUATION OF TELECOMMUNICATION SYSTEMS AND OTHERS

(71) Applicant: Kinematics, LLC, Phoenix, AZ (US)

(72) Inventors: Adam P. Plesniak, Huntington Beach, CA (US); Kenneth D. Miller, Statesville, NC (US); Kyle Zech, Phoenix, AZ (US); Mark Henderson, La Verne, CA (US)

(21) Appl. No.: 17/402,365

(22) Filed: Aug. 13, 2021

Related U.S. Application Data
(63) Continuation-in-part of application No. 17/344,806, filed on Jun. 10, 2021.
Application No. 17/344,806 is a continuation of application No. 16/133,375, filed on Sep. 17, 2018, now abandoned.
(60) Provisional application No. 62/565,513, filed on Sep. 29, 2017.

(51) Int. Cl. F16H 57/039; H02S 20/32; F16H 1/16; F16H 19/08

(52) U.S. Cl. CPC F16H 57/039; F16H 19/08; F16H 1/16; H02S 20/32

(57) ABSTRACT

Slew drive systems for rotational and axial load bearing, e.g., in applications including satellite-based telecommunications systems, are disclosed herein. In some cases, slew drive systems disclosed herein can improve efficiency, accuracy, and/or reliability of telecommunication systems while reducing the cost and complexity of manufacture. For example, a slew drive system can comprise a threaded plug and a retaining ring in addition to a worm gear, a plurality of tapered roller bearings, and a worm wheel, allowing a significant reduction in material and labor costs of slew drive manufacture, which can be critical in the manufacture of expensive telecommunications system actuator assemblies.

### TECHNICAL FIELD

The present disclosure relates to slew drives which include a worm gear and a worm wheel that are secured within a housing. In particular, the housing includes a first distal housing section and a second distal housing section which operate to receive a threaded plug and a retaining ring so as to reduce the number of components used in the assembly of such slew drives. The first distal housing section includes a threaded section operative to engage the threaded plug and the second distal housing section includes a groove operative to receive the retaining ring. In some cases, the slew drive systems disclosed herein are used in the actuation of satellite dishes or arrays and other telecommunications equipment. For example, slew drive systems described herein can improve accuracy, efficiency, and reliability of systems used for tracking objects and signals in space (e.g., as the Earth rotates) while, in many cases, simultaneously reducing cost of manufacture.

### BACKGROUND

A slew drive is a type of gearbox which can withstand axial and radial loads while transmitting torque to drive an external unit. Applications where a slew drive is utilized include solar trackers, wind turbines, lifts, and cranes, to name a few. Slew drives generally include a threaded shaft having a threaded section, commonly referred to as the worm gear and a geared wheel having teeth, commonly referred to as the worm wheel. The threaded section of the worm gear engages the teeth of the worm wheel thereby rotating the worm wheel. The worm gear rotates along its own axial axis at a rotational speed causing the worm wheel to rotate along its axial axis at a different rotational speed. The axes of rotation of the worm gear and worm wheel are, in general, perpendicular, although they can be at a different angle.

A slew drive further includes bearings, seals, and other components which are secured within a housing. The housing includes two ends where two bearings, such as two tapered roller bearings, are positioned. The worm gear is secured to the housing via the two bearings. The seals operate to maintain the lubricants within the housing. The housing of a conventional slew drive includes two end caps and a number of bolts, typically 4 on each side, in order to exert an axial compressive force on the worm gear which in turn exerts the axial force on the teeth of the work wheel. This configuration ensures improved engagement between the threads of the worm gear and the teeth of the worm wheel.

An objective of the present design is to replace the two end caps and the associated bolts with a threaded plug and a retaining ring. This configuration reduces costs in material and labor. Specifically, the number of components used in the slew drive are reduced thereby lowering the cost of material, and at the same time making the assembly of the slew drive easier and less labor intensive thereby lowering the cost of labor.

### SUMMARY

In one aspect, a slew drive is disclosed wherein the slew drive comprises a threaded plug, a retaining ring, a housing comprising a first distal housing section and a second distal housing section, wherein the first distal housing section includes a threaded section operative to receive the threaded plug, wherein the second distal housing section includes a groove operative to receive the retaining ring, a worm gear comprising a central threaded section, a first distal shaft section including a first shoulder. and a second distal shaft section including a second shoulder, a first bearing seated on the first distal shaft section and abutting the first shoulder and the threaded plug., a second bearing seated on the second distal shaft section and abutting the second shoulder and the retaining ring, and a worm wheel comprising worm-wheel teeth operative to engage the central threaded section of the worm gear, whereby rotating the threaded plug in engagement with the threaded section, a compressive force is exerted upon the worm gear.

Preferably, at least one of the first bearing and the second bearing comprises one of a roller bearing and a ball bearing.

Preferably, the roller bearing comprises one of a tapered roller bearing, a cylindrical roller bearing, a spherical roller bearing, and a needle roller bearing.

Preferably, the ball bearing comprises one of a deep groove ball bearing, an angular ball bearing, and a thrust ball bearing.

Preferably, the first bearing is seated on the first distal shaft section via one of a clearance fit, a transition fit, and an interference fit.

Preferably, the retaining ring is a circlip.

Preferably, the slew drive further comprises at least one of thread lock and sealant applied over the first distal housing section.

Preferably, the slew drive further comprises an oil seal disposed within the second distal housing section.

In another aspect, a housing in combination with a slew drive is disclosed wherein the slew drive comprises a threaded plug, a retaining ring, a worm gear comprising a central threaded section, a first distal shaft section including a first shoulder, and a second distal shaft section including a second shoulder, a first bearing seated on the first distal shaft section and abutting the first shoulder and the plug, a second, bearing seated on the second distal shaft section and abutting, the second shoulder and the retaining ring, and a worm wheel comprising worm-wheel teeth operative to engage the central threaded section of the worm gear, whereby rotating the threaded plug in engagement with the threaded section, a compressive force is exerted upon the worm gear, wherein the housing comprises a first distal housing section which includes a threaded section operative to receive the threaded plug, and a second distal housing section which includes a groove operative to receive the retaining ring.

Preferably, at least one of the first bearing and the second bearing comprises one of a roller bearing and a. ball bearing.

Preferably, the roller bearing comprises one of a tapered roller bearing, a cylindrical roller bearing, a spherical roller bearing, and a needle roller bearing.

Preferably, the ball bearing comprises one of a deep groove ball bearing, an angular ball bearing, and a thrust ball bearing.

Preferably, the first bearing is seated on the first distal shaft section via one of a clearance fit, a transition fit, and an interference fit.

Preferably, the retaining ring is a circlip.

Preferably, the slew drive further comprises at least one of thread lock and sealant applied over the first distal housing section.

Preferably, the slew drive further comprises an oil seal disposed within the second distal housing section.

In another aspect, a method of assembling a slew drive is disclosed wherein the method comprises providing a threaded plug, providing a retaining ring, providing a housing comprising a first distal housing section and a second distal housing section, wherein the first distal housing section includes a threaded section operative to receive the threaded plug, wherein the second distal housing section includes a groove operative to receive the retaining ring, providing a worm, gear comprising a central threaded section, a first distal shaft section including a first shoulder, and a second distal shaft section including a second shoulder, providing a first bearing seated on the first distal shaft section and abutting the first shoulder and the threaded plug, providing a second bearing seated on the second distal shaft section and abutting the second shoulder and the retaining ring, and providing a worm wheel comprising worm-wheel teeth operative to engage the central threaded section of the won't gear, whereby rotating the threaded plug in engagement with the threaded section, a compressive force is exerted upon the worm gear.

Preferably, the method further comprises providing at least one of thread lock and sealant applied over the first distal housing section.

Preferably, the method further comprises providing an oil seal disposed within the second distal housing section.

In various cases, an actuation system can comprise: a telecommunication dish operably coupled to a slew drive, wherein the slew drive comprises: a threaded plug; a retaining ring; a housing comprising a first distal housing section and a second distal housing section, wherein the first distal housing section includes a threaded section operative to receive the threaded plug, wherein the second distal housing section includes a groove operative to receive the retaining ring; a worm gear comprising a central threaded section, a first distal shaft section including a first shoulder, and a second distal shaft section including a second shoulder; a first bearing seated on the first distal shaft section and abutting the first shoulder and the threaded plug; a second bearing seated on the second distal shaft section and abutting the second shoulder and the retaining ring; a worm wheel coupled to said component, wherein the worm wheel comprises worm-wheel teeth operative to engage the central threaded section of the worm gear; whereby upon rotating the threaded plug in engagement with the threaded section, a compressive force is exerted upon the worm gear to rotate said component. In various cases, an actuation system can comprise: a slew drive that is configured to be operably coupled to a component selected from the group consisting of a telecommunication dish, a radar dish, and a solar array, wherein the slew drive comprises: a threaded plug; a retaining ring; a housing comprising a first distal housing section and a second distal housing section, wherein the first distal housing section includes a threaded section operative to receive the threaded plug, wherein the second distal housing section includes a groove operative to receive the retaining ring; a worm gear comprising a central threaded section, a first distal shaft section including a first shoulder, and a second distal shaft section including a second shoulder; a first bearing seated on the first distal shaft section and abutting the first shoulder and the threaded plug; a second bearing seated on the second distal shaft section and abutting the second shoulder and the retaining ring; a worm wheel coupled to said component, wherein the worm wheel comprises worm-wheel teeth operative to engage the central threaded section of the worm gear; whereby upon rotating the threaded plug in engagement with the threaded section, a compressive force is exerted upon the worm gear to rotate said component. In some cases, the slew drive is configured to rotate said component at a speed of 0.05 degrees per second to 0.5 degrees per second. In some cases, said component has a weight ranging from 1 kg to 3,000 kg. In some cases, said component has a weight ranging from 1 kg to 5 kg. In some cases, said component has a weight ranging from 500 kg to 3,000 kg. In some cases, said component is rotated along a plane that is perpendicular to an axial axis of the worm gear. In some cases, a system further comprises a lubricant. In some cases, the lubricant is a #0 grease. In some cases, at least one of the first bearing and the second bearing comprises one of a roller bearing or a ball bearing. In some cases, the roller bearing comprises one of a tapered roller bearing, a cylindrical roller bearing, a spherical roller bearing, and a needle roller bearing. In some cases, the ball bearing comprises one of a deep groove ball bearing, an angular ball bearing, and a thrust ball bearing. In some cases, the first bearing is seated on the first distal shaft section via one of a clearance fit, a transition fit, and an interference fit. In some cases, the retaining ring is a circlip. In some cases, the system further comprises at least one of thread lock and sealant applied on the threaded section of the first distal housing section. In some cases, the system further comprises a first wheel ball bearing, wherein the worm wheel comprises a first race of the first wheel ball bearing and the housing comprises a second race of the first wheel ball bearing. In some cases, the system further comprises a second wheel ball bearing, wherein the worm wheel comprises a first race of the second wheel ball bearing and the housing comprises a second race of the second wheel ball bearing. In some cases, the first wheel ball bearing is disposed on a first side of the worm wheel and the second wheel ball bearing is disposed on a second side of the worm wheel. In some cases, the first wheel ball bearing comprises a grease shield. In various aspects, a method can comprises: (a) providing a slew drive that comprises: a threaded plug; a retaining ring; a housing comprising a first distal housing section and a second distal housing section, wherein the first distal housing section includes a threaded section operative to receive the threaded plug, wherein the second distal housing section includes a groove operative to receive the retaining ring; a worm gear comprising a central threaded section, a first distal shaft section including a first shoulder, and a second distal shaft section including a second shoulder; a first bearing seated on the first distal shaft section and abutting the first shoulder and the threaded plug; a second bearing seated on the second distal shaft section and abutting the second shoulder and the retaining ring; a worm wheel comprising worm-wheel teeth operative to engage the central threaded section of the worm gear; (b) coupling the worm wheel of the slew drive to said component; and (c) rotating the threaded plug in engagement with the threaded section to thereby exert a compressive force upon the worm gear to rotate said component.

### DESCRIPTION OF THE DRAWINGS

FIG. 1A shows a left perspective view of the front side of a conventional slew drive which includes a housing having an end plate which is secured to the housing using 4 bolts, in accordance with embodiments.

FIG. 1B shows a right perspective view of the front side of the slew drive where a second end plate is secured to the housing using 4 bolts, in accordance with embodiments.

FIG. 1C shows a front cross-sectional front view of the slew drive which shows a worm gear engaged with a worm wheel, two tapered roller bearings fitted into both ends of the housing and the worm gear is fitted into the inner races of the bearings, the end plates abutting the housing and the bearings, the bolts used to secure the worm gear in the axial direction while imparting an axial compressive force on the worm gear to enhance and improve teeth engagement between the wore gear and the worm wheel. A seal is disposed within the end plate to prevent the lubricant from exiting the housing, in accordance with embodiments.

FIG. 2A shows a left perspective view of the front side of a preferred embodiment of an integrated slew drive illustrating a distal housing section of a housing included in the slew drive, in accordance with embodiments.

FIG. 2B shows a right perspective view of the rear side of the integrated slew drive of FIG. 2A illustrating the other distal housing section of the slew drive housing, in accordance with embodiments.

FIG. 3A shows a left perspective cross-sectional view of a preferred embodiment of an integrated slew drive having a slew drive housing which comprises a first distal housing section having a threaded section and a second distal housing section having a groove. The first distal housing section receives a threaded plug that threads into the threaded section. The groove is configured to receive a retaining ring, in accordance with embodiments.

FIG. 3B shows a front cross-sectional view of the front side of the slew drive of FIG. 3A, in accordance with embodiments.

FIG. 3C shows a close-up view of section 338 of FIG. 3A, in accordance with embodiments.

FIG. 3D shows a close-up view of section 339 of FIG. 3B, in accordance with embodiments.

FIG. 4A shows an exploded cross-sectional view of a preferred embodiment of an integrated slew drive including a threaded plug, a retaining ring, a seal, two tapered roller bearings, a worm gear, a worm wheel, and a housing having a first distal housing section and a second distal housing section, in accordance with embodiments. FIG. 4B shows a close-up of section 439 of FIG. 4A, in accordance with embodiments.

FIG. 5 shows drive efficiency of slew drives comprising SHC 100 grease or grade #0 synthetic grease during accelerate pendulum testing, in accordance with embodiments.

FIG. 6 shows slew drive tooth wear during accelerate pendulum testing in slew drives comprising SHC 100 grease or grade #0 synthetic grease, according to embodiments.

FIG. 7A shows a slew drive comprising a single ball bearing, in accordance with embodiments.

FIG. 7B shows a slew drive comprising a hole, in accordance with embodiments.

FIG. 8 shows a slew drive comprising a plurality of ball bearings, in accordance with embodiments.

FIG. 9 shows a ball bearing grease shield of a slew drive, in accordance with embodiments.

FIG. 10 shows a slew drive comprising dry bearings, in accordance with embodiments.

### DETAILED DESCRIPTION

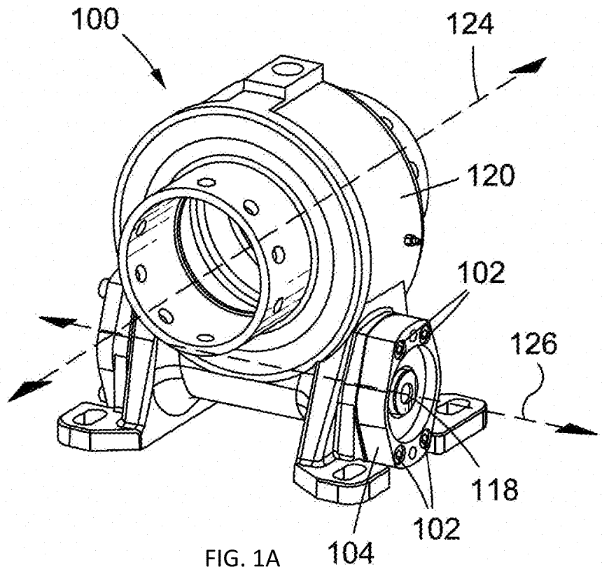

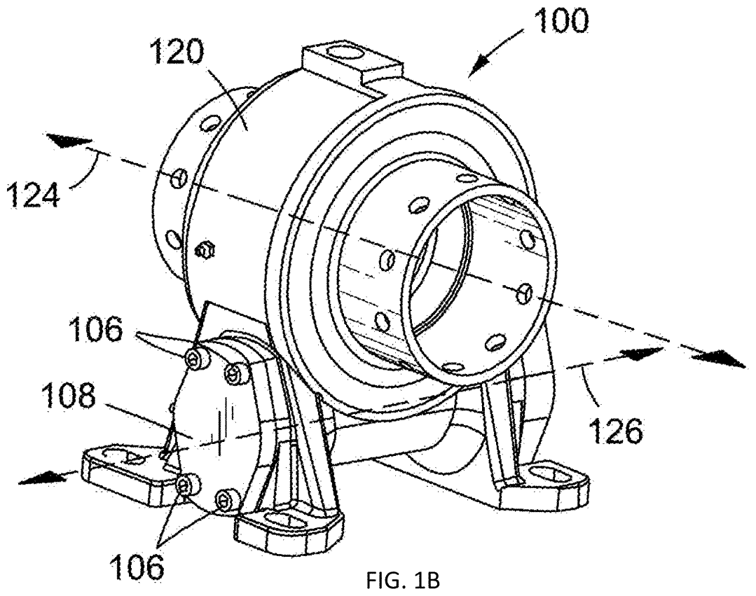

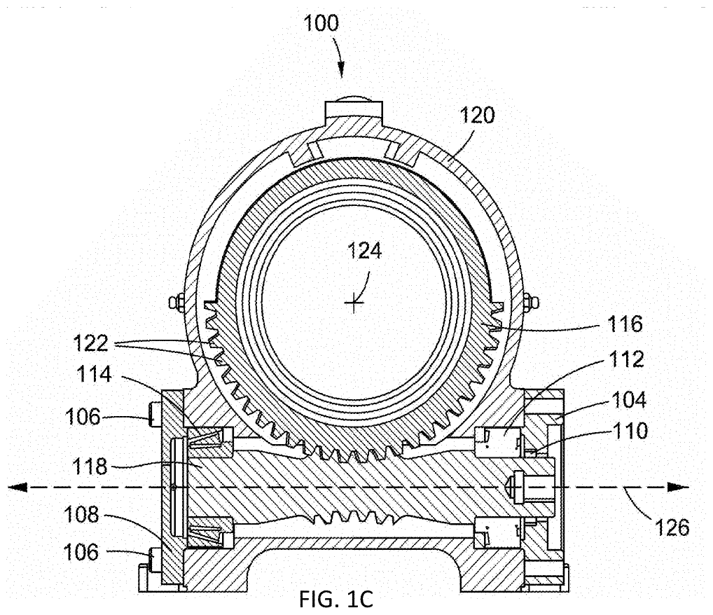

FIG. 1A depicts a left perspective view of the front side of a conventional slew drive 100 which includes a housing 120 having an end plate 104 which is secured to the housing 120 utilizing four bolts 102. The end plate 104 includes a circular hole where an end section of a worm gear 118 partially protrudes out of the hole to be driven by a reducer assembly and a motor (not shown).

FIG. 1B depicts a right perspective view of the front side of the slew drive 100 shown in FIG. 1A where a second end plate 108 is secured to the housing 120 using four bolts 106. The end plates 104 and 108 are commonly made from steel which add considerable weight to the slew drive 100. In addition to adding unwanted weight to the slew drive 100, the end plates 104 and 108 require eight bolts, i.e., bolts 102 and 106, to couple with the housing 120, adding considerable labor to the total assembly and/or disassembly of the slew drive 100.

FIG. 1C depicts a front cross-sectional front view of the slew drive 100 shown in FIG. 1A and FIG. 1B, where the worm gear 118 is engaged with a worm wheel 116. Specifically, a central threaded section of the worm gear 118 engages worm-wheel teeth 122 of the worm wheel 116. The worm gear 118 rotates along its axial axis 126 which in turn rotates the worm wheel 116 along its axial axis 124. A motor and reducer assembly (not shown) are used to drive the worm gear 118 which in turn drives the worm wheel 116. The axes 124 and 126 are ordinarily perpendicular but can be oriented at a different angle depending on the application.

In this configuration, two tapered roller bearings 112 and 114 are fitted into both ends of the housing 120. The worm gear 118 is fitted into the inner races of the bearings 112 and 114. The end plates 104 and 108 abut the housing 120 and the bearings 112 and 114. The bolts 102 (not visible in this cross-sectional view) and bolts 106 are used to secure the worm gear in the axial direction while imparting an axial compressive force on the worm gear 118 to enhance and improve teeth engagement between the worm gear 118 and worm wheel 116. A seal 110 is disposed within the end plate 104 to prevent the lubricant from exiting the housing 120.

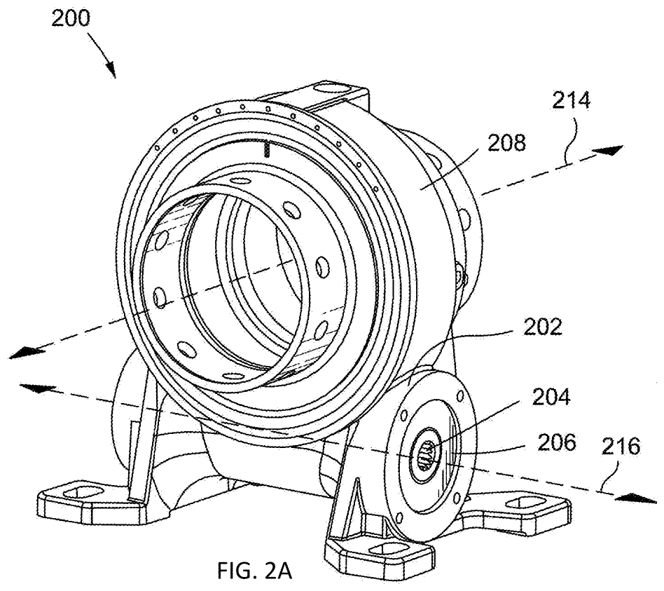

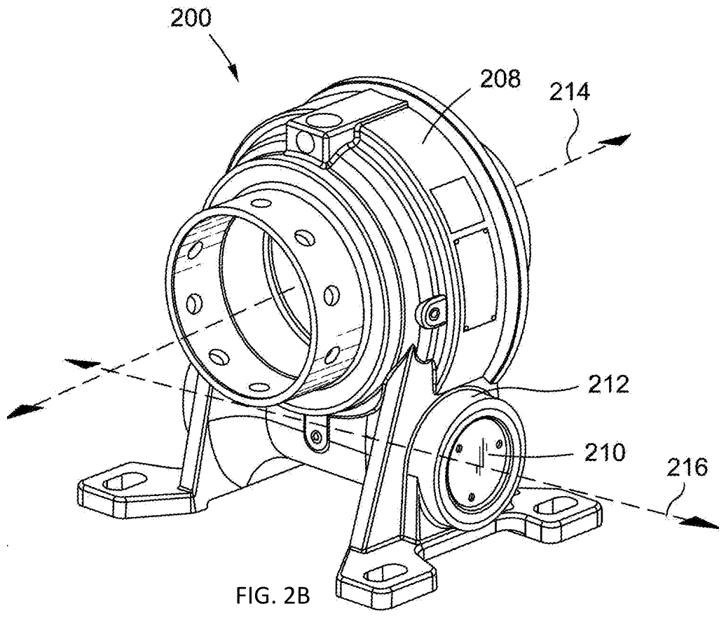

FIG. 2A depicts a left perspective view of the front side of a preferred embodiment of an integrated slew drive 200 illustrating a distal housing section 202 of a housing 208 included in the slew drive 200. A worm gear 204 partially protrudes out of a hole that has been cut into an oil seal 206, the latter being used to seal the lubricants within the housing 208. Comparing the slew drive 200 with that of the conventional slew drive 100, it can readily be seen that the integrated slew drive 200 does not require an end plate such as the end plate 104 and bolts such as the bolts 102, used in the slew drive 100, thereby, reducing the overall weight of the slew drive 200 and the labor to assemble it.

FIG. 2B depicts a right perspective view of the rear side of the integrated slew drive 200 shown in FIG. 2A. Another distal housing section 212 of the housing 208 of the slew drive 200 is used to receive a threaded plug 210. Comparison of this side of the slew drive 200 with the corresponding side of the slew drive 100 shows the elimination of the end plate 108 and bolts 106, further reducing the total weight of the slew drive 200 and the labor required for its assembly.

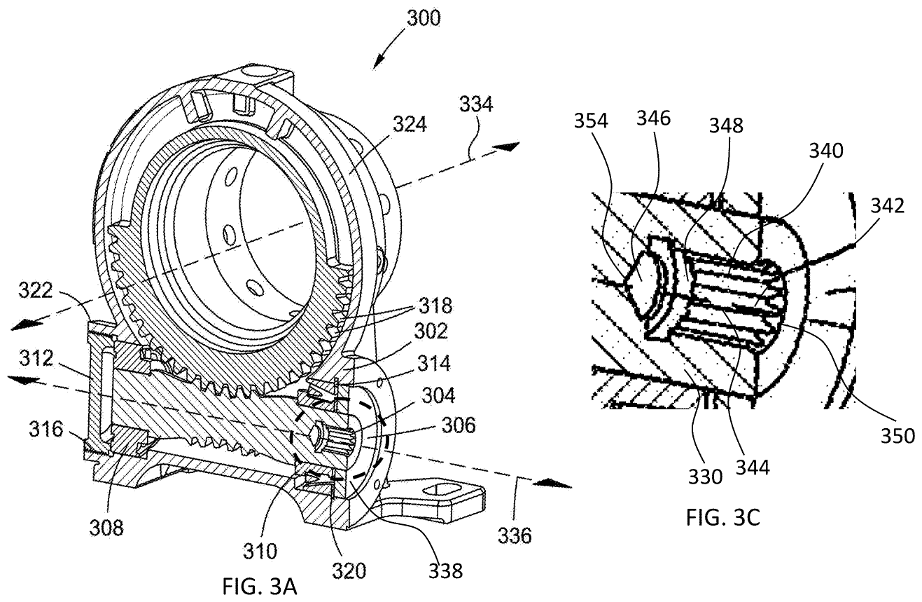

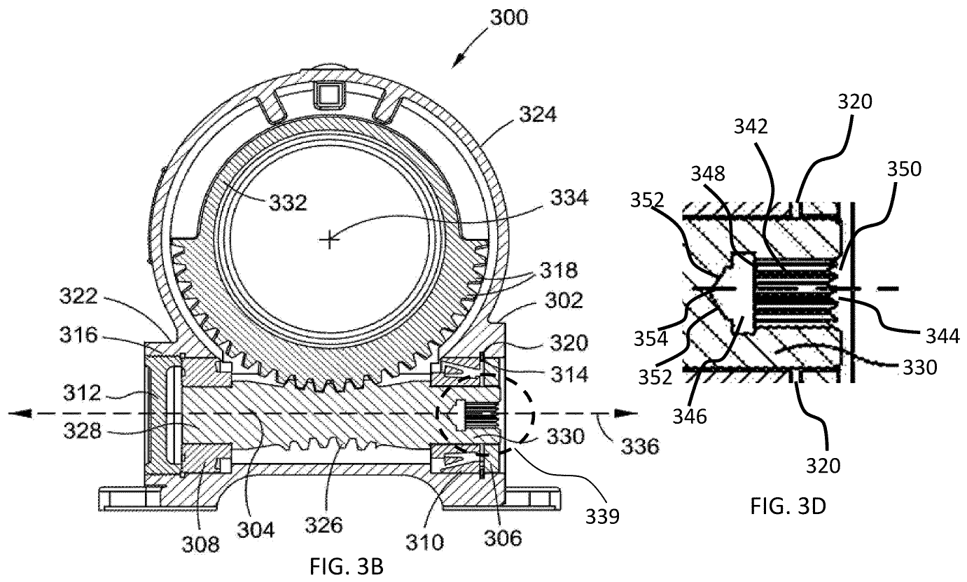

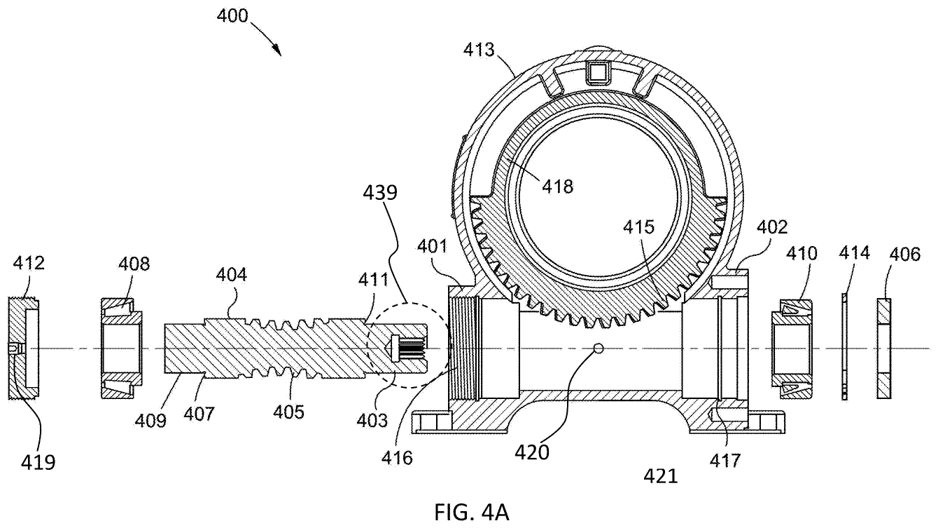

FIG. 3A depicts a left perspective cross-sectional view of a preferred embodiment of an integrated slew drive 300. The slew drive 300 comprises a housing 324 which comprises a first distal housing section 322 having a threaded section 316. The housing 324 further includes a second distal housing section 302 having a groove 320. The first distal housing section 322 receives a threaded plug 312 that threads into the threaded section 316. The groove 320 is machined into the second distal housing section 302 to receive a retaining ring 314. In one instance, the retaining ring 314 is a circlip.

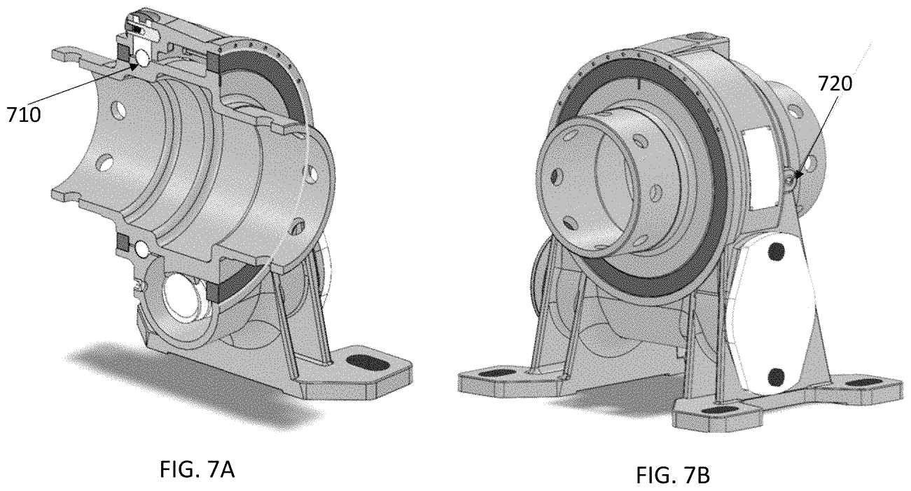

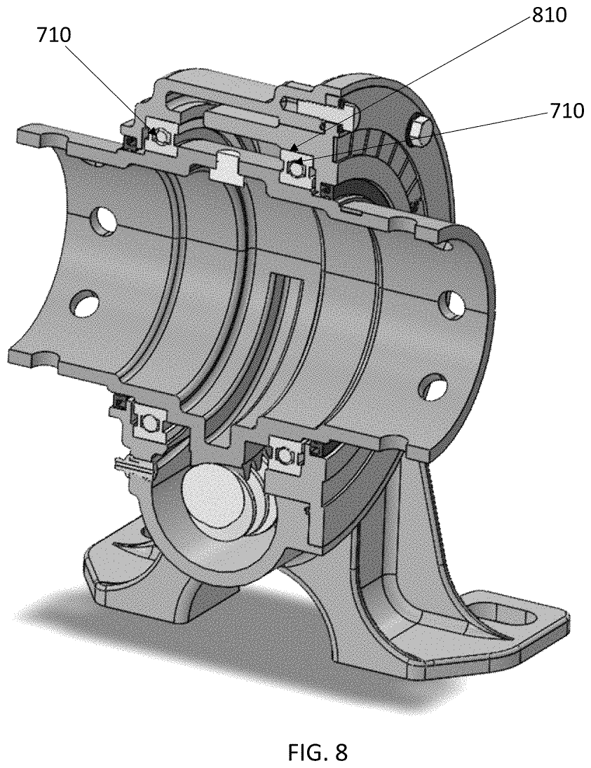

A worm gear 304 can be secured to the slew drive housing 324 by a first bearing 308 and a second bearing 310. The first bearing 308 and the second bearing 310 may be selected from a variety of bearings depending on the application. For instance, roller bearings and/or ball bearings can be utilized to secure the worm gear 304 to the housing 324. Roller bearings may be any one of a tapered roller bearing, a cylindrical roller bearing, a spherical roller bearing, and a needle roller bearing. Ball bearings may be any one of a deep groove ball bearing, an angular ball bearing, and a thrust ball bearing. In this preferred embodiment, the first bearing 308 and the second bearing 310 can both be tapered roller bearings. In some cases, a slew drive can utilize a single ball bearing (e.g., wherein the bottom race is integrated as part of the worm gear and the top race is part of the housing), for example, as shown in FIG. 7A. In some cases, a slew drive comprising such a ball bearing (e.g., for securing the worm gear to the slew drive housing), can also comprise a hole 720 (e.g., a grease zerk), which can be on the exterior of the housing and may be used to add grease to the ball bearing race, e.g., as shown in FIG. 7B. In some cases, a slew drive can comprise a plurality (e.g., two) ball bearings 710 (e.g., wherein the bottom race is integrated as part of the worm gear and the top race is part of the housing), for example, as shown in FIG. 8. In some cases, the two ball bearings 710 can be one either side of the worm gear, e.g., as shown in FIG. 8. In some cases, a slew drive comprising a plurality of ball bearings (e.g., for securing the worm gear to the slew drive housing) can comprise a plurality of holes (e.g., for adding a lubricant to each ball bearing track).

In some cases, a slew drive can comprise a ball bearing having a raceway with a diameter of at least 187 mm and can survive an overturning moment at least 13.5 kN-m (kilonewton-meters) and can have a survivability torque of at least 7.0 kN-m. In some cases, a slew drive can comprise a ball bearing having a raceway with a diameter of at least 229 mm and can survive an overturning moment at least 33.9 kN-m (kilonewton-meters) and can have a survivability torque of at least 39.0 kN-m. In some cases, a slew drive can comprise a ball bearing having a raceway with a diameter of at least 305 mm and can survive an overturning moment at least 54.2 kN-m (kilonewton-meters) and can have a survivability torque of at least 49.9 kN-m. In some cases, a slew drive can comprise a ball bearing having a raceway with a diameter of at least 356 mm and can survive an overturning moment at least 67.8 kN-m and can have a survivability torque of at least 54.4 kN-m. In some cases, a slew drive can comprise a ball bearing having a raceway with a diameter of at least 432 mm can survive an overturning moment at least 135.6 kN-m and can have a survivability torque of at least 65.6 kN-m. In some cases, a slew drive can comprise a ball bearing having a raceway with a diameter of at least 533 mm and can survive an overturning moment at least 203.4 kN-m and can have a survivability torque of at least 81.0 kN-m. In some cases, a slew drive can comprise a ball bearing having a raceway with a diameter of at least 635 mm can survive an overturning moment at least 271.1 kN-m and can have a survivability torque of at least 89.1 kN-m. In some cases, a slew drive can comprise a ball bearing having a raceway with a diameter of at least 711 mm can survive an overturning moment at least 457.5 kN-m and can have a survivability torque of at least 180.7 kN-m.

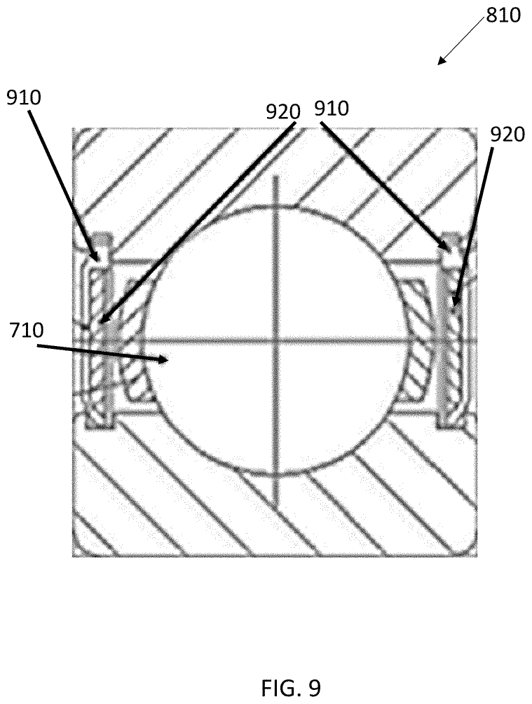

A slew drive can comprise a grease shield 810, e.g., as shown in FIG. 9. In some cases, a grease shield 810 can be disposed between the top and bottom races of a ball bearing 710 (e.g., a deep groove ball bearing). A grease shield 810 can aid in encouraging grease to stay interior to the bearing during the lifetime of the slew drive. In some cases, a grease shield can comprise one or more grease shield seals 910. In some cases, a grease shield seal can comprise a plastic or rubber. For instance, a grease shield seal 910 can comprise nitrile rubber (nitrile butadiene rubber, NBR), hydrogenated nitrile butadiene rubber (HNBR), and/or polyvinyl chloride (PVC). In some cases, a grease shield 810 can comprise a rigid backing 920, for example, to add rigidity to the seal of the grease shield. In some cases, a rigid backing 920 can comprise a metal. In some cases, a rigid backing 920 can be semi-rigid or flexible. In some cases, a rigid backing 920 can be inside of the grease shield seal 910.

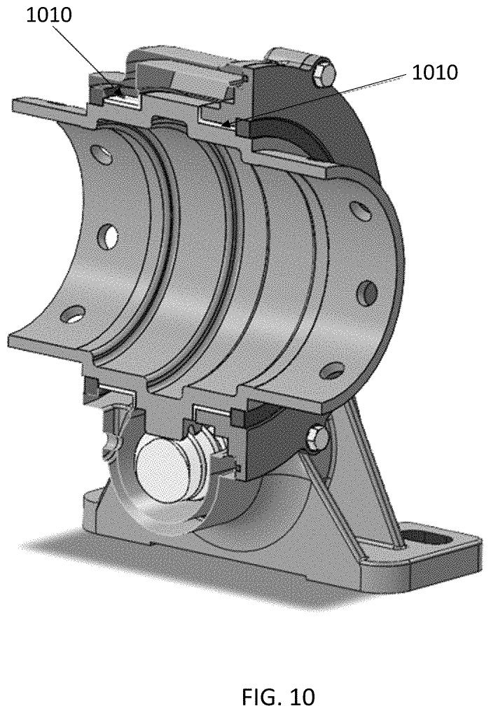

In some cases, a slew drive can comprise one or more dry bearings 1010 (e.g., as shown in FIG. 10), for instance, in place of one or more than ball bearing(s) 710. In some cases, a dry bearing 1010 can comprise an interface track, which can allow the worm wheel to slide over an inner surface of the housing as it turns (e.g., without the need for lubrication). In some cases, a dry bearing 1010 can comprise (e.g., be made from or be coated fully or partially with) a low-friction material, such as polytetrafluoroethylene (PTFE).

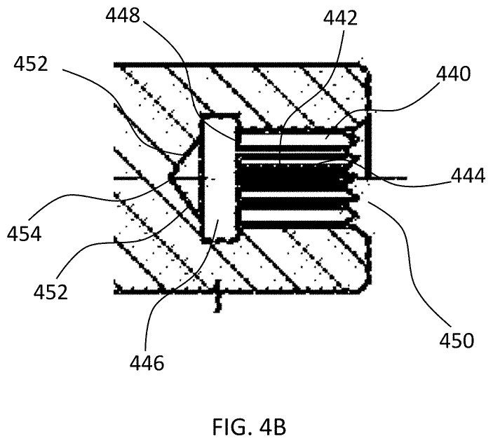

FIG. 3B depicts a front cross-sectional view of the front side of the slew drive 300 shown in FIG. 3A. The worm gear 304 comprises a central threaded section 326, a first distal shaft section 328 having a first shoulder (see FIG. 4A), and a second distal shaft section 330 having a second shoulder (see FIG. 4A). The central threaded section 326 of the worm gear 304 engages worm-wheel teeth 318 of a worm wheel 332. The worm gear 304 rotates around its axial axis 336 and rotates the worm wheel 332 around its axial axis 334. FIG. 3C shows a magnified view of the section denoted by 338 in FIG. 3A, and FIG. 3D shows a magnified view of the section denoted by 339 in FIG. 3B. Referring to FIG. 3C and FIG. 3D, the second distal shaft section 330 can include a bore 340 having internal splines 342. The internal splines 342 can extend longitudinally along the bore 340. The second distal shaft section 330 can further comprises an interior hollow section 346 adjacent to the bore 340. The bore 340 can comprise a first opening 348 extending to the interior hollow section 346. The bore 340 can also comprise a second opening 350 located at a distal end of the second distal shaft section 330. The interior hollow section 346 can comprise an annular cutout 347, and a tapered portion 351 having sloping interior sidewalls 352. The annular cutout 347 can be located between the tapered portion 351 and the bore 340. An outer diameter d1 of the annular cutout 347 may be greater than a diameter d2 of the second opening 350. The sloping interior sidewalls 352 can taper inward and converge at a point 354 located on a longitudinal central axis of the worm gear 304. The sloping interior sidewalls 352 can also taper outward to the annular cutout 347. The bore 340 and the interior hollow section 346 can be located between the second shoulder and a distal end of the second distal shaft section. The internal splines 342 of the bore 340 may not extend into the interior hollow section 346 of the second distal shaft section 330. In some cases, the system can be configured to rotate the worm wheel 332 around its axial axis 334 at a rate of from 0.05 degrees per second to 0.5 degrees per second.

The first tapered roller bearing 308 is seated on the first distal shaft section 328, abutting the first shoulder and the plug 312, and the second tapered roller bearing 310 is seated on the second distal shaft section 330, abutting the second shoulder and the retaining ring 314. The first tapered roller bearing 308 may be seated on the first distal shaft section 328 via a variety of fits, such as a clearance fit, a transition fit, and an interference fit. Similarly, the second tapered roller bearing 310 may be seated on the first distal shaft section 328 via a variety of fits, such as a clearance fit, a transition fit, and an interference fit. In some cases, incorporation of roller bearing(s) (e.g., tapered roller bearing(s) and/or ball bearing(s)) in a slew drive can aid in improving driveline efficiency of the slew drive. A seal, such as an oil seal, 306 is seated on the second distal shaft section 330, abutting the retaining ring 314 to prevent lubricant from exiting the housing 324. In some cases, controlling the seal outer diameter relative to the housing inner diameter can help to prevent lubricant leakage, especially in slew drives comprising oil lubricant. In some cases, the tolerance on a seal outer diameter and a mating housing inner diameter can be Φ80(+0.35/+0.2)/Φ80(+0.046/0). In some cases, these surfaces may be unpainted (e.g., bare metal), for example, to help preserve lifetime seal performance. In some cases, controlling the roughness of the worm gear can help to prevent lubricant leakage. In some cases, roughness of the worm is controlled to a range of 0.1 to 0.7, 0.15 to 0.65, or 0.2 to 0.6 (e.g., wherein Ra is the arithmetic average of the absolute values of the profile height deviations from the mean line).

As the threaded plug 312 is rotated in engagement with the threaded section 316 of the first distal housing section 322 of the housing 324, an axial compressive force is exerted upon the worm gear 304 through the first tapered roller bearing 308 to ensure improved engagement between the thread section 326 of the worm gear 304 and the worm-wheel teeth 318 of the worm wheel 332. The retaining ring 314 exerts the same magnitude compressive force on the worm gear 304 but in the opposite direction through the second tapered roller bearing 310. In some cases, an amount of compression exerted on the worm gear 118 (e.g., by the tapered roller bearing(s) of the slew drive) can be adjusted by loosening or tightening an end plate, plug, or bolts of the slew drive. In some embodiments, a preferred level of compression on the worm gear 118 can be achieved by adjusting the fit (e.g., tightness) of an end plate, plug, or bolts of a slew drive to result in a non-loaded starting torque to rotate the worm gear of from 1 N-m to 12 N-m, from 2 N-m to 11 N-m, from 3 N-m to 10 N-m, or within a range greater than 3 N-m and less than 10 N-m.

FIG. 4 depicts an exploded cross-sectional view of a preferred embodiment of an integrated slew drive 400. The slew drive 400 comprises a housing 413 which includes a first distal housing section 401 having a threaded section 416. The housing 413 further includes a second distal housing section 402 which includes a groove 417.

The slew drive 400 further comprises a threaded plug 412 and a retaining ring 414. The first distal housing section 401 receives the threaded plug 412 that threads into the threaded section 416. The retaining ring 414 is disposed in the groove 417. The slew drive 400 further comprises a worm gear 404. The worm gear 404 comprises a central threaded section 405, a first distal shaft section 409 having a first shoulder 407, and a second distal shaft section 403 having a second shoulder 411. The slew drive 400 further comprises a first tapered roller bearing 408 and a second tapered roller bearing 410. The worm gear 404 is secured to the housing 413 by the first tapered roller bearing 408 and the second tapered roller bearing 410. The first tapered roller bearing 408 is seated on the first distal shaft section 409, abutting the first shoulder 407 and the plug 412. The second tapered roller bearing 410 is seated on the second distal shaft section 403, abutting the second shoulder 411 and the retaining ring 414. FIG. 4B shows a magnified view of the section denoted by 439 in FIG. 4A. Referring to FIG. 4B, the second distal shaft section 403 can include a bore 440 having internal splines 442. The internal splines 442 can extend longitudinally along the bore 440. In some cases, the second distal shaft section 403 can comprise grooves 444. The second distal shaft section 403 can further comprise an interior hollow section 446 adjacent to the bore 440. The bore 440 can comprise a first opening 448 extending to the interior hollow section 446. The bore 440 also can comprise a second opening 450 located at a distal end of the second distal shaft section 403. The interior hollow section 446 can comprise an annular cutout 447, and a tapered portion 451 having sloping interior sidewalls 452. The annular cutout 447 can be located between the tapered portion 451 and the bore 440. An outer diameter d1 of the annular cutout 447 can be greater than a diameter d2 of the second opening 450. The sloping interior sidewalls 452 can taper inward and converge at a point 454 located on a longitudinal central axis of the worm gear 404. The sloping interior sidewalls 452 can also taper outward to the annular cutout 447. The bore 440 and the interior hollow section 446 can be located between the second shoulder 411 and a distal end of the second distal shaft section 403. The internal splines 442 of the bore 440 may not extend into the interior hollow section 446 of the second distal shaft section 403.

The slew drive 400 further comprises a worm wheel 418 having worm-wheel teeth 415. The central threaded section 405 of the worm gear 404 engages the worm-wheel teeth 415 of the worm wheel 418. As the threaded plug 412 is rotated in engagement with the threaded section 416 of the first distal housing section 401 of the housing 413, an axial compressive force is exerted upon, the worm gear 404 ensuring improved engagement between the threaded section 405 of the worm gear 404 and the worm-wheel teeth 415 of the worm wheel 418. The slew drive 400 further comprises an oil seal 406 which is seated on the second distal shaft section 403 and abutting the retaining ring 414 to prevent lubricant from exiting the housing 413.

In a preferred embodiment, the retaining ring 414 is disposed in the groove 417 and the second tapered roller bearing 410 is disposed within the second distal housing section 402 and to the left of the retaining ring 417. In one instance, an interference fit is used to dispose the second tapered roller bearing 410 within the second distal housing section 402. The worm gear 404 is inserted in the inner race of the second tapered roller bearing 410 such that the second tapered roller bearing 410 is seated on the second distal shaft section 403 and abutting the second shoulder 411. The first tapered roller bearing 408 is then seated on the first distal shaft section 409 until it abuts the first shoulder 407. The worm wheel 418 is then disposed within the housing 413 and engages the threaded section 405 of the worm gear 404. The oil seal 406 is then seated on the second distal shaft section 403 abutting the retaining ring 414 so as to prevent lubricant from exiting the housing 413. The plug 412 is then inserted into the first distal housing section 401 and rotated in engagement with the threaded section 416 to impart an axial compressive force upon the worm gear 404 to improve engagement between the threaded section 405 of the worm gear 404 and the worm-wheel teeth 415 of the worm wheel 418.

In some cases, slew drive 400 can comprise one or more holes, e.g., for adding a lubricant. In some cases, plug 412 can comprise a hole 419, e.g., for adding a lubricant. For example, a plug 412 can comprise a hole 419 on a distal end surface of the plug 412, as shown in FIG. 4A. In some cases, a hole 420 can be located in a side wall of a worm housing shaft 421 portion of housing 413, for example, as shown in FIG. 4A. Inclusion of hole 419 and hole 420 in a slew drive 400 can allow more complete and even lubrication of the worm gear 404 within the housing 413. In some cases, inclusion of a plurality of holes (e.g., 419 and 420) in a slew drive 400 can allow targeted lubrication of the system, for example, if a first hole of the plurality of holes is spatially separated from a second hole of the plurality of holes (e.g., as shown in FIG. 4A, see hole 419 and hole 420).

In some cases, the lubricant can be oil. In some cases, oil can be added to a slew drive via a hole, e.g., in the housing such as hole 420 or in a plug 412, as shown in FIG. 4A. In some cases, a hole (e.g., hole 419 and/or hole 420) can comprise an oil fill plug. In some cases, inclusion of oil in a slew drive can render more than one lubricant hole unnecessary. For example, hole 419 may be omitted from a slew drive 400 when an oil is used as a lubricant for the slew drive 400 (e.g., wherein the oil can be added through a single hole, such as hold 420). In some cases, a slew drive described herein can be configured such that the same oil used to lubricate the worm/gear interface also lubricates the roller bearings.

In some cases, the lubricant can be a grease. In some cases, for example in systems wherein the lubricant is a grease), a hole of a slew drive 400 (e.g., hole 419 and/or hole 420) can comprise a grease zerk. In some cases, a grease can be EP2 grade grease. In some cases, a grease useful in a slew drive 400 can be a synthetic grease. A grease useful in a slew drive 400 can be synthetic NLGI grade #00, #0, #1, or #2. In some cases, inclusion of a NLGI (National Lubricating Grease Institute) grade #0 synthetic grease can offer improvement to wear on the slew drive 400 and/or one or more of its components, for example, compared to the use of a conventional grease (e.g., such as Mobil™ SHC 100 grease). In some cases, use of a grade #0 synthetic grease can increase relative drive-line performance efficiency by from 1% to 30%, from 5% to 25%, from 10% to 25%, from 15% to 25%, or from 15% to 20%. In some cases, use of a grade #0 synthetic grease in a slew drive 400 can increase relative drive-line performance efficiency by at least 1%, at least 5%, at least 10%, at least 15%, at least 20%, at least 25%, or at least 30%. In some cases, use of a grade #0 grease in a slew drive 400 can reduce gear wear by from 1% to 70%, from 1% to 66%, from 5% to 66%, from 10% to 66%, from 15% to 66%, from 20% to 66%, from 25% to 66%, from 30% to 66%, from 35% to 66%, from 40% to 66%, from 45% to 66%, from 50% to 66%, from 55% to 66%, from 60% to 66%, or from 65% to 66%. In some cases, use of a grade #0 grease in a slew drive 400 can reduce gear wear by up to 50%, up to 55%, up to 60%, up to 65%, up to 66%, or up to 70%.

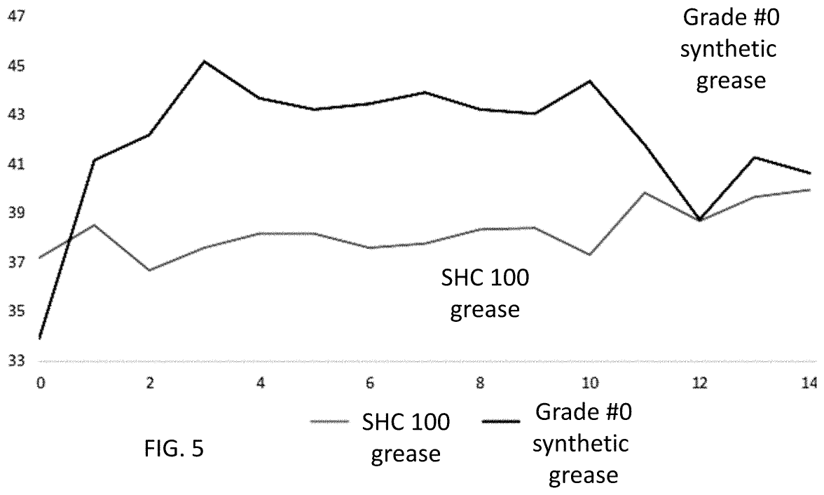

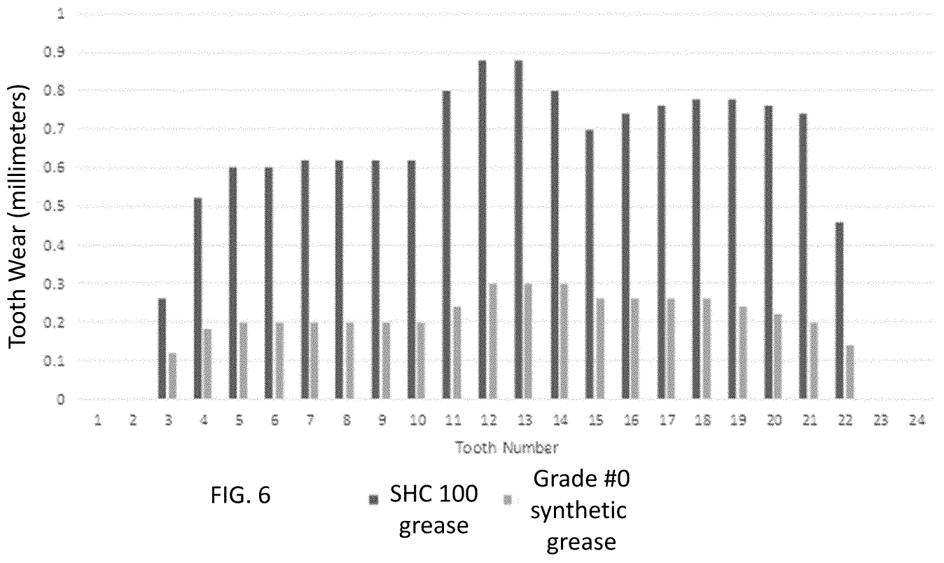

In some cases, use of a NLGI grade #0 synthetic grease can improve drive efficiency, for example, as tested in an accelerate pendulum test. Results from an accelerate pendulum test in which a torque (max 1200 Newton-meters (N-m)) is placed on a slew drive, and the slew drive is run at 0.1 revolutions per minute (RPM) output gear speed in an accelerated fashion are shown in FIG. 5. In particular, accelerate pendulum testing protocol used to obtain data shown in FIG. 5 was: cycle time: 468 seconds (s), (run time: 408 s and stop time: 60 s); oriented in vertical position (0 degree) at start, rotate to negative 60 degrees for 102 s, stop for 30 seconds, rotate to positive 60 degrees for 204 seconds, stop for 30 seconds, rotate to 0 degree position for 102 seconds; drive efficiency was measured every 1,000 cycles. Data shows that slew drives comprising grade #0 synthetic grease consistently improved drive efficiency compared to slew drive systems comprising SHC 100 grease. Analysis of slew drive wear, measured by disassembling tested slew drives at the end of testing and measuring tooth wear, showed that slew drive systems comprising grade #0 synthetic grease also showed decreased tooth wear compared to systems comprising SHC 100 grease (FIG. 6).

In some cases, the slew drive is configured to rotate a telecommunications assembly. For example, a slew drive described herein can be used to rotate a telecommunication dish (e.g., in a plane perpendicular to an axial axis of the worm gear 404). In some cases, rotating the worm gear 404 can cause a telecommunications assembly (e.g., comprising a telecommunication dish, such as a telecommunication dish that is from 1 kilograms (kg) to 5 kg, 5 kg to 10 kg, 10 kg to 100 kg, from 100 kg to 1,000 kg, from 1,000 kg to 5,000 kg, from 1 kg to 10 kg, from 1 kg to 1,000 kg, from 1 kg to 3,000 kg, or at least 3,000 kg) to rotate in a plane perpendicular to an axial axis of the worm gear 404. In some cases, a slew drive is configured to support and/or be coupled to a component selected from: a satellite dish, a satellite array, a solar array, a bracket or support (e.g., such as a satellite dish bracket/support or a solar array bracket or support), a crane arm, a lift (e.g., a bucket lift arm), a positioner arm, a robotic arm, a medical imaging device (e.g., an X-ray machine, a mammography machine, or a CT scanner), or an adjustable bed, such as a hospital bed.

In some cases, a slew drive disclosed herein can support an axial load of 1 N (newton) to 1 kN (kilonewtons), 1 kN to 5 kN, 5 kN to 10 kN, 10 kN to 15 kN, 15 kN to 20 kN, 20 kN to 25 kN, 25 kN to 30 kN, or more than 30 kN. In some cases, a slew drive disclosed herein can support an axial load of less than 1 N, at least 1 N, at least 1 kN, at least 5 kN, at least 10 kN, at least 15 kN, at least 20 kN, at least 25 kN, or at least 30 kN.

In some cases, a slew drive disclosed herein can sustain a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, 2,500 N-m to 3,000 N-m, 3,000-N-m to 3,500 N-m, or more than 3,500 N-m. In some cases, a slew drive disclosed herein can sustain a tilting torque (e.g., without failure or overturning) of at least 1 N-m, at least 500 N-m, at least 1,000 N-m, at least 1,500 N-m, at least 2,000 N-m, at least 2,500 N-m, at least 3,000 N-m, or at least 3,500 N-m.

In some cases, a slew drive disclosed herein can support an axial load of at least 1 N while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, 2,500 N-m to 3,000 N-m, 3,000-N-m to 3,500 N-m, or more than 3,500 N-m. In some cases, a slew drive disclosed herein can support an axial load of at least 1 kN while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, 2,500 N-m to 3,000 N-m, 3,000-N-m to 3,500 N-m, at least 3,500 N-m, or more than 3,500 N-m. In some cases, a slew drive disclosed herein can support an axial load of at least 5 kN while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, 2,500 N-m to 3,000 N-m, 3,000-N-m to 3,500 N-m, or at least 3,000 N-m. In some cases, a slew drive disclosed herein can support an axial load of at least 10 kN while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, 2,000 N-m to 2,500 N-m, up to 2,500 N-m, or at least 2,500 N-m. In some cases, a slew drive disclosed herein can support an axial load of at least 15 kN while sustaining a tilting torque (e.g., without failure or overturning) of 1 N-m (newton-meter) to 500 N-m, 500 N-m to 1,000 N-m, 1,000 N-m to 1,500 N-m, 1,500 N-m to 2,000 N-m, or at least 1,500 N-m. In some cases, a slew drive disclosed herein can support an axial load of at least 20 kN while sustaining a tilting torque (e.g., without failure or overturning) of 1 N-m (newton-meter) to 500 N-m, 500 N-m to 1,000 N-m, 1,000 N-m to 1,500 N-m, or at least 1,000 N-m. In some cases, a slew drive disclosed herein can support an axial load of at least 25 kN while sustaining a tilting torque (e.g., without failure or overturning) of 1 N-m (newton-meter) to 500 N-m, 500 N-m to 1,000 N-m, up to 500 N-m, or at least 500 N-m.

While preferred embodiments of the present invention have been shown and described herein, it will be obvious to those skilled in the art that such embodiments are provided by way of example only. Numerous variations, changes, and substitutions will now occur to those skilled in the art without departing from the inventions. It should be understood that various alternatives to the embodiments of the inventions described herein may be employed in practicing the inventions. It is intended that the following claims define the scope of embodiments of the inventions and that the methods and structures within the scope of these claims and their equivalents be covered thereby. For purposes of comparing various embodiments, certain aspects and advantages of these embodiments are described. Not necessarily all such aspects or advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

What is claimed is:

1. An actuation system comprising:
a telecommunication dish operably coupled to a slew drive, wherein the slew drive comprises:
a threaded plug;
a retaining ring;
a housing comprising a first distal housing section and a second distal housing section, wherein the first distal housing section includes a threaded section operative to receive the threaded plug, wherein the second distal housing section includes a groove operative to receive the retaining ring;
a worm gear comprising a central threaded section, a first distal shaft section including a first shoulder, and a second distal shaft section including a second shoulder;
a first bearing seated on the first distal shaft section and abutting the first shoulder and the threaded plug;
a second bearing seated on the second distal shaft section and abutting the second shoulder and the retaining ring;
a worm wheel coupled to said component, wherein the worm wheel comprises worm-wheel teeth operative to engage the central threaded section of the worm gear;
whereby upon rotating the threaded plug in engagement with the threaded section, a compressive force is exerted upon the worm gear to rotate said component.

2. An actuation system comprising:
a slew drive that is configured to be operably coupled to a component selected from the group consisting of a telecommunication dish, a radar dish, and a solar array, wherein the slew drive comprises:
a threaded plug;
a retaining ring;
a housing comprising a first distal housing section and a second distal housing section, wherein the first distal housing section includes a threaded section operative to receive the threaded plug, wherein the second distal housing section includes a groove operative to receive the retaining ring;
a worm gear comprising a central threaded section, a first distal shaft section including a first shoulder, and a second distal shaft section including a second shoulder;
a first bearing seated on the first distal shaft section and abutting the first shoulder and the threaded plug;
a second bearing seated on the second distal shaft section and abutting the second shoulder and the retaining ring;
a worm wheel coupled to said component, wherein the worm wheel comprises worm-wheel teeth operative to engage the central threaded section of the worm gear;
whereby upon rotating the threaded plug in engagement with the threaded section, a compressive force is exerted upon the worm gear to rotate said component.

3. The system of claim 2, wherein the slew drive is configured to rotate said component at a speed of 0.05 degrees per second to 0.5 degrees per second.

4. The system of claim 3, wherein said component has a weight ranging from 1 kg to 3,000 kg.

5. The system of claim 4, wherein said component has a weight ranging from 1 kg to 5 kg.

6. The system of claim 4, wherein said component has a weight ranging from 500 kg to 3,000 kg.

7. The system of claim 2, wherein said component is rotated along a plane that is perpendicular to an axial axis of the worm gear.

8. The system of claim 2, further comprising a lubricant.

9. The system of claim 8, wherein the lubricant is a #0 grease.

10. The actuation system of claim 2, wherein at least one of the first bearing and the second bearing comprises one of a roller bearing or a ball bearing.

11. The actuation system of claim 10, wherein the roller bearing comprises one of a tapered roller bearing, a cylindrical roller bearing, a spherical roller bearing, and a needle roller bearing.

12. The actuation system of claim 10, wherein the ball bearing comprises one of a deep groove ball bearing, an angular ball bearing, and a thrust ball bearing.

13. The actuation system of claim 2, wherein the first bearing is seated on the first distal shaft section via one of a clearance fit, a transition fit, and an interference fit.

14. The actuation system of claim 2, wherein the retaining ring is a circlip.

15. The actuation system of claim 2, further comprising at least one of thread lock and sealant applied on the threaded section of the first distal housing section.

16. The actuation system of claim 2, further comprising a first wheel ball bearing, wherein the worm wheel comprises a first race of the first wheel ball bearing and the housing comprises a second race of the first wheel ball bearing.

17. The actuation system of claim 16, further comprising a second wheel ball bearing, wherein the worm wheel comprises a first race of the second wheel ball bearing and the housing comprises a second race of the second wheel ball bearing.

18. The actuation system of claim 17, wherein the first wheel ball bearing is disposed on a first side of the worm wheel and the second wheel ball bearing is disposed on a second side of the worm wheel.

19. The actuation system of claim 16, wherein the first wheel ball bearing comprises a grease shield.

20. A method comprising:
(a) providing a slew drive that comprises:
a threaded plug;
a retaining ring;
a housing comprising a first distal housing section and a second distal housing section, wherein the first distal housing section includes a threaded section operative to receive the threaded plug, wherein the second distal housing section includes a groove operative to receive the retaining ring;
a worm gear comprising a central threaded section, a first distal shaft section including a first shoulder, and a second distal shaft section including a second shoulder;
a first bearing seated on the first distal shaft section and abutting the first shoulder and the threaded plug;
a second bearing seated on the second distal shaft section and abutting the second shoulder and the retaining ring;
a worm wheel comprising worm-wheel teeth operative to engage the central threaded section of the worm gear;
(b) coupling the worm wheel of the slew drive to said component; and
(c) rotating the threaded plug in engagement with the threaded section to thereby exert a compressive force upon the worm gear to rotate said component.
